(19) United States
(12) Patent Application Publication
(10) Pub. No.: US 2010/0076745 A1
(43) Pub. Date: Mar. 25, 2010

(54) Apparatus and Method of Detecting Community-Specific Expression

(76) Inventor: Hiromi Oda, Tokyo (JP)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 11/990,495

(22) PCT Filed: Jul. 13, 2006
(86) PCT No.: PCT/JP2006/314000

§ 371 Date: Jan. 15, 2008

(30) Foreign Application Priority Data
Jul. 15, 2005 (JP) 2005-207810

(51) Int. Cl. G06F 17/20; G06F 17/30

(52) U.S. Cl. 704/1; 707/769; 707/E17.014; 704/E11.001

(57) ABSTRACT

Conventional publications concerning collections of community specific expressions include collections of technical terms including nouns and compound nouns in technical fields. However, application to new expressions other than nouns is difficult. Even in the field of collection of unknown words and new words, the objective is limited substantially to nouns, and no techniques of collecting new expressions systematically have been proposed. The invention solves the above problem by (a) means for extracting n-gram collocations specific in a predetermined community from a set of documents used in the community, (b) means for selecting a radical which might be a core of specific expressions, (c) means for expanding the selected radical toward the front and back, and (d) means for screening the expanded radicals according to the grammar.

### CLAIM FOR PRIORITY

The present invention claims priority under 35 U.S.C. 119 to Japanese PCT Application Serial No. PCT/JP2006/314000, filed on Jul. 13, 2006, which claims priority to Japanese Patent Application Serial No. JP2005-207810 filed on Jul. 15, 2005, the disclosures of which are hereby incorporated by reference in their entireties.

### TECHNICAL FIELD

The present invention relates to a device and a method which detect novel expressions specific to a community from expressions used in the community based on a word-formation theory.

### BACKGROUND

In a community of people actively discussing specific interests and themes are frequently generated novel expressions specific to the community. For example, in a community discussing tastes of sake are often used expressions such as “hine”, “hiki no aru”, and “kireru”. Among people who like wines are observed expressions such as “full body”, “medium dry”, “tarukou (cask flavor)”, and “atokuchi (aftertaste)”. These expressions are not difficult technical terms used by people skilled in the art, but types of vocabularies which carry implications naturally understood as expressions expressing tastes of the wines and sake by the people who are familiar therewith. Moreover, expressions collected as “wakamonogo (young persons' language)” of high school, university students, and the like can be considered as expressions specific to a community. Recently, there have been found many novel expressions in communities of people who are gathering around bulletin boards on the Internet and the like.

Examples of publications include, for instance, [1] JP 2002-297589, A “COLLECTING METHOD FOR UNKNOWN WORD”, [2] JP H5-113997, A “DICTIONARY DATA COLLECTING DEVICE”, [3] JP 2004-265440, A “UNKNOWN WORD REGISTRATION DEVICE AND METHOD AND RECORD MEDIUM”, [4] JP 2005-309853, A “METHOD/PROGRAM/SYSTEM FOR CONVERTING VOCABULARY BETWEEN PROFESSIONAL DESCRIPTION AND NON-PROFESSIONAL DESCRIPTION”, [NP1] Hiroshi Nakagawa, Hiroaki Yumoto, Tatsunori Mori (2003), “Extraction of Technical Terms Based on Frequencies of Appearances and Conjugations”, Natural Language Processing, 10 (1), 27-45, [NP2] Keita Tsuji, Fuyuki Yoshikane (2004), “Basic Research Toward Identification of Novel Terms To Be Important in Specific Fields”, Proceedings of 10th Annual Conference of the Association of Natural Language Processing (pp. 189-191), [NP3] Atsushi Fujii, Katunobu Itou, Tomoyoshi Akiba (2003), IPA Exploratory Software Project “CYCLONE: Building of Most Powerful Dictionary Site”, www.ipa.go.jp/about/news/event/pdf/29A7-fujii.pdf, and [NP4] Akihiko Yonekawa (1998), “Wakamonogo wo kagaku suru”, Tokyo: Meijishoin, the disclosures of which are hereby incorporated by reference in their entireties.

Conventional publications relating to the collection of expressions specific to communities mainly includes collection of technical terms and collection of unknown words. As the collection of technical terms, for example, there are studies disclosed in Non-Patent Documents 1 and 2 [NP1] and [NP2], which mostly relate to a collection of nouns and compound nouns in specialized fields. As a result of such a limitation, although it is possible to use an algorithm based on a score focusing on overlaps and conjugations of single nouns, it is difficult to apply the algorithm to expressions other than nouns.

Moreover, collection of unknown words and novel terms is an important theme for building dictionaries and the like, and there exist techniques handling this theme in existing patents such as [1] JP 2002-297589 A “COLLECTING METHOD FOR UNKNOWN WORD” and [3] JP 2004-265440 A “UNKNOWN WORD REGISTRATION DEVICE, METHOD, AND RECORDING MEDIUM”.

However, as reported by, for example, in [3] JP 2004-265440 A “UNKNOWN WORD REGISTRATION DEVICE, METHOD, AND RECORDING MEDIUM”, it is a difficult problem to detect unknown words in Japanese, and most of the methods including the method described in [1] JP 2002-297589 A “COLLECTING METHOD FOR UNKNOWN WORD” basically collect manually or heuristically terms which have not been registered to a dictionary. Moreover, subjects to be detected as the unknown words are limited mostly to nouns, and the detection rarely focuses on collection of actually novel expressions.

There is a field of sociolinguistics which collects and analyzes “wakamonogo” used by high school and university students, as discussed in [NP4]. Although this research seems to be close to the present invention as existing research on expressions specific to a community, there is not proposed a method which regularly collects the young persons' terms and trendy terms in the field of sociolinguistics.

### SUMMARY

The following device is disclosed to solve the problem.

(1) A device for searching for an expression specific to a predetermined community from a set of documents used in the predetermined community, the device for including the following means (a) to (d):

(a) means for extracting an n-gram collocation specifically used by the community;

(b) means for selecting a first word stem which is a possible core of a specific expression;

(c) means for selecting an extended word stem based on values calculated using a statistical significance of the first word stem, and a statistical significance of a second word stem which contains a previous or subsequent element of the first word stem; and

(d) means for selecting an expression specific to the predetermined community from the extended word stems according to a word formation rule of a certain language.

(2) A device described in the item (1) is characterized by further including means for collecting documents for the set of documents by means of data search by using a term contained in a predetermined term list as a keyword.

(3) A device described in the items (1) and (2) is characterized in that the means for extracting an n-gram collocation includes means for using a document used in a plurality of communities to extract an n-gram collocation based on a comparison between a statistical significance of the n-gram collocation used in the predetermined community and a statistical significance of the n-gram collocation used in other communities.

Further, the following method is disclosed to solve the problem.

(4) A method for searching for an expression specific to a predetermined community from a set of documents used in the predetermined community, the method including the following steps of:

(a) extracting an n-gram collocation specifically used by the community;

(b) selecting a first word stem which is a possible core of a specific expression;

(c) selecting an extended word stem based on values calculated using a statistical significance of the first word stem, and a statistical significance of a second word stem which contains a previous or subsequent element of the first word stem; and

(d) selecting an expression specific to the predetermined community from the extended word stems according to a word formation rule of a certain language.

(5) A method described in the item (4) is characterized by further including the step of collecting documents for the set of documents by means of data search by using a term contained in a predetermined term list as a keyword.

Still further, the following program is disclosed to solve the problem.

(6) A program for searching for an expression specific to a predetermined community from a set of documents used in the predetermined community, the program controlling a computer to operate the following means (a) to (d):

(a) means for extracting an n-gram collocation specifically used by the community;

(b) means for selecting a first word stem which is a possible core of a specific expression;

(c) means for selecting an extended word stem based on values calculated using a statistical significance of the first word stem, and a statistical significance of a second word stem which contains a previous or subsequent element of the first word stem; and

(d) means for selecting an expression specific to the predetermined community from the extended word stems according to a word formation rule of a certain language.

(7) The program described in the item (6) is characterized by further including means for collecting documents for the set of documents by means of data search by using a term contained in a predetermined term list as a keyword.

According to the present invention, collecting expressions used in a desired community, and understanding implications thereof facilitate communication between members of the community, and further can assist confirmation of an identity thereof. Moreover, they can also be utilized to analyze characteristics and natures of the community. Moreover, it seems to be important to analyze what are discussed in communities of users in a development of a product and the like, and collecting expressions specific to the community and understanding implications thereof thus seem to largely contribute to the purpose thereof.

The present invention is an extension of phrasing between major parts of speech, and can be applied to other languages. As an example in English, the following expression becomes possible: “He 747'ed to Chicago.” is an example of verbalization of a model number of airplane. Also, the expression “The web-logging is becoming a social phenomenon.” can be used and this is the example of nominalization of “Web-log (keep logs on the web).”

### BRIEF DESCRIPTION OF THE DRAWINGS

FIG. 1 shows a diagram showing an example of a system embodying the present invention.

FIG. 2 shows a block diagram of a PC embodying a part of the present invention.

FIG. 3 shows a block diagram of a device which detects community-specific expressions according to the present invention.

FIG. 4 shows a flowchart according to the present invention.

FIG. 5 shows a flowchart of document collection according to the present invention.

FIG. 6 shows a flowchart used to determine whether or not an extended word stem is appropriate.

FIG. 7 shows a flowchart used to determine whether an extended word stem conforms to word formation rules.

### DETAILED DESCRIPTION

A description will now be given of a best mode.

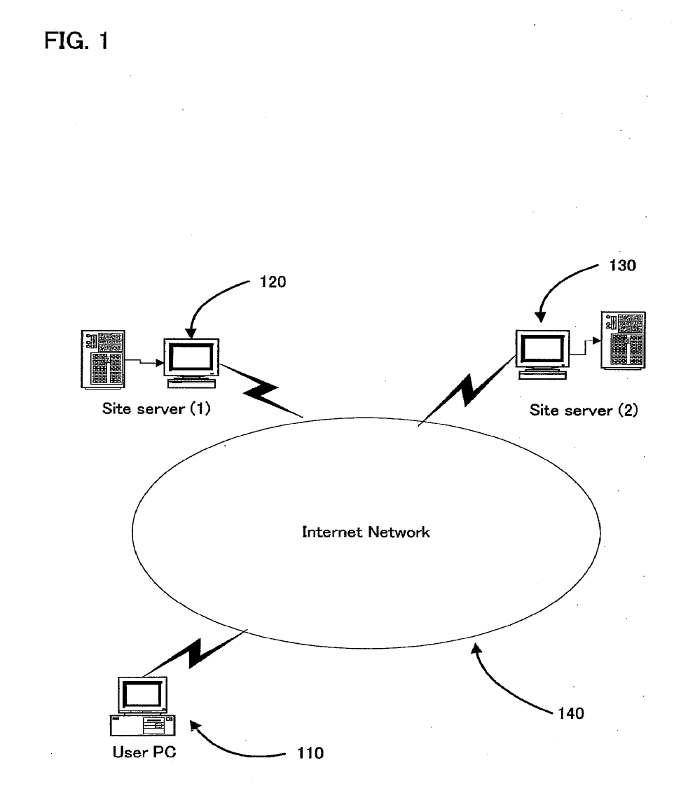

FIG. 1 shows an example of a system implementing the present invention. To a network 140 are connected a user PC 110, a site server (1) 120, a site server (2) 130, and the like. A user operates the user PC 110 to access the site server (1) 120, site serve (2) 130, and the like connected to the network 140, and uses a search tool and the like to obtain necessary information. Although the present invention shows a search over the Internet as the embodiment, the present invention is not limited to this system, and can be applied to any other systems which can search for information by means of other methods. The obtained information is processed by a computer program on the user PC to obtain a desired result.

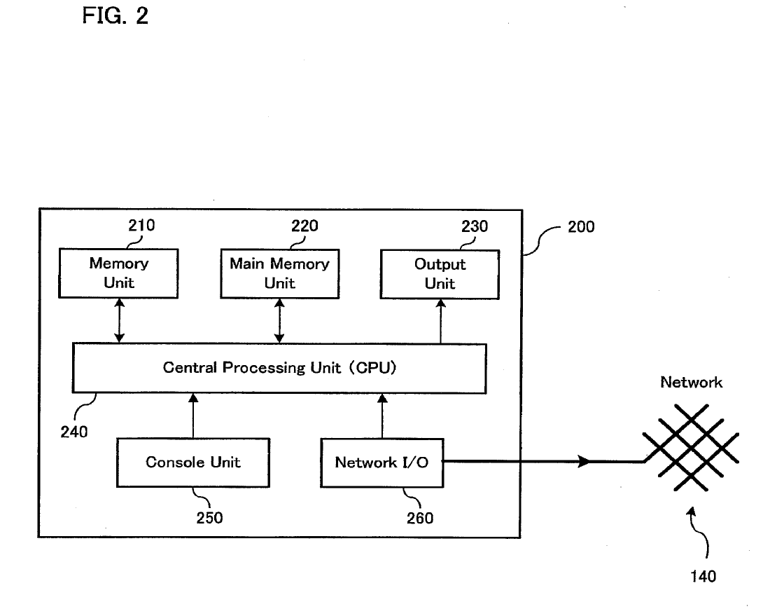

FIG. 2 shows the user PC implementing a part of the present invention. In an enclosure 200 are included a storage device 210, a main memory 220, an output device 230, a central processing unit (CPU) 240, a console unit 250, and a network I/O 260. The user operates the console unit 250 to obtain necessary information from respective sites on the Internet via the network I/O. The central processing unit 240 downloads a document processing program stored in the storage device 210 into a memory, uses the information searched on the Internet to carry out predetermined data processing, and displays a result thereof on the output device 230.

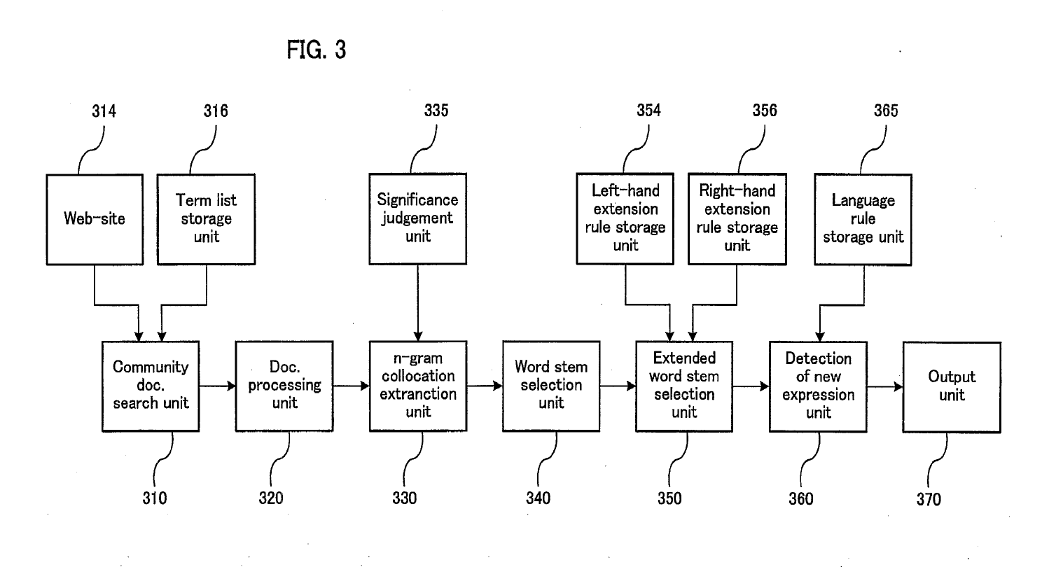

FIG. 3 shows a block diagram of a community-specific expression detecting device according to the present invention. Reference numeral 310 denotes a community document search unit; 314, a Web-site; 316, a term list storage unit; 320, a document processing unit; 330, an n-gram collocation extraction unit; 335, a significance judgment unit; 340, a word stem selection unit; 350, an extended word stem selection unit; 354, a left-hand extension rule storage unit; 356, a right-hand extension rule storage unit; 360, a novel expression selection unit; 365, language rule storage unit; and 370, an output unit. A detailed description will now be given thereof.

Basic Algorithm

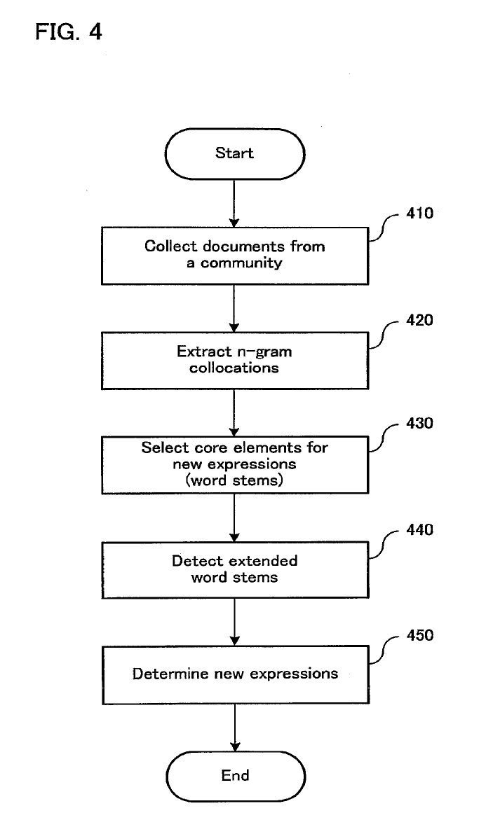

With reference to a flowchart shown in FIG. 4, a description will now be given of a basic algorithm according to the present invention.

Step 410: Collect documents from communities

Step 420: Extract n-gram collocations

Step 430: Select core elements for novel expressions (word stems)

Step 440: Detect extended word stems

Step 450: Determine novel expressions

Detail of Algorithm

Hereinbelow, a detailed description will now be given of the algorithm.

(1) Collect Documents from Predetermined Communities (Step 410 in FIG. 4)

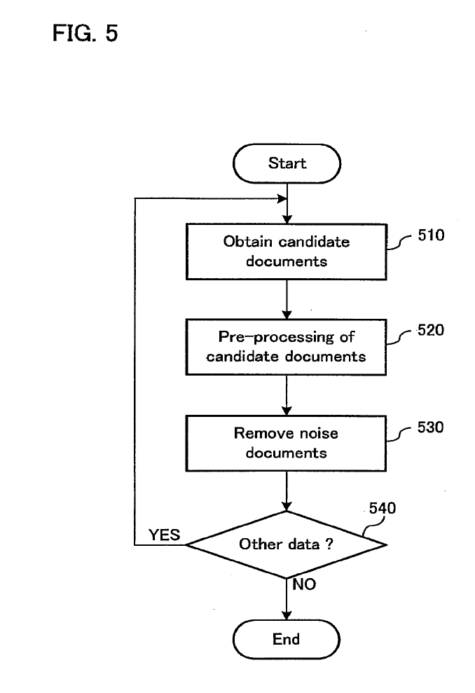

In the following steps, a set of documents used in the predetermined communities relatively close to each other are first collected. Refer to an algorithm shown in FIG. 5.

Step 510: Obtain candidate documents based on specification of terms

Step 520: Pre-processing of candidate documents

Step 530: Remove noise documents

Step 540: Determine necessity of search for documents from other communities.

Hereinbelow, a detailed description will now be given of the respective steps.

(1-1) Step 510: Obtain Candidate Documents

In order to embody the present invention, the term list containing predetermined terms are used to collect documents used by members of predetermined communities. Here, the term list is stored in the term list storage unit (316 in FIG. 3).

The term list is a set of terms used as keywords in one community. For example, when “wine lovers” are selected as the one community, elements of the term list include wine brands. According to the brands described in the wine term list, information on the wines is collected by means of a search tool for the Internet (314 in FIG. 3). On this occasion, brands such as “Auslese”, “Chateau Cure-Bon”, “Chateau Margaux”, and “Vin Santo Toscano” can be specified as the brands. These terms are used to search databases for candidate documents. As the databases, any databases storing relevant information may be used, and according to this embodiment, a description will be given of a method to search for candidate documents by means of search engines for the Internet.

(1-2) Step 520: Pre-Processing of Candidate Documents

The pre-processing first extracts information corresponding to documents from the information from the Web pages, and analyzes the documents. Then, the documents are rewritten while leaving spaces between words, and content words, generic particles, auxiliary verbs, and the like are extracted, and characteristic values representing characteristics of these documents are obtained. Based on these characteristic values, noise documents are removed as described below. Moreover, there are selected in advance a small number of model documents which are considered typical for documents to be collected.

(1-3) Step 530: Remove Noise Documents

The documents used to automatically collect information from the Web pages on the Internet contain various information, and often cannot be used as they are. According to this embodiment, from these documents are removed documents corresponding to garbage documents, list documents, and diary-type documents as the noise documents.

A description will be given of the garbage documents, the list documents, and the diary-type documents.

(a) Garbage Documents

A garbage document refers to a document which satisfies all conditions such as a document with a small content word number, and a document with a low proper noun ratio. The content word number refers to the number of content words contained in a document on one Web page. The content words are words corresponding to nouns, verbs, adjectives, and adverbs other than generic particles and auxiliary verbs. The proper nouns mentioned here are nouns recognized as proper nouns in the public. The proper noun ratio is a ratio of the number of proper nouns to the number of content words appearing on one Web page.

(b) List Documents

A list of information document is defined as a document which satisfies all conditions which are a document with a high proper noun ratio and a document with a low correlation coefficient between content words and generic particles/auxiliary verbs. The list information document is a document which simply stores information on subjects in a certain field as a list in a site on the Internet.

(c) Diary-Type Documents

A diary-type document is defined as document which satisfies all conditions which are a document with a low proper noun ratio relating to a certain community, a document with a low correlation with model documents based on content word n-grams, and a document with a high correlation with model documents based on generic particle/auxiliary verb n-grams. These documents are so-called documents used as sites to write personal diaries, and documents mainly carrying other information such as that on sites relating to sales floors in department stores. Based on the above definitions, the garbage documents, list documents, and diary-type documents are removed as noise documents.

(1-4) Step 540: Determine Necessity of Search for Documents from Other Communities

According to Steps 510 to 530, the set of documents used in the predetermined communities is collected. In Step 540, a set of documents used in other communities is collected in the same manner.

Next, the collected sets of documents used in a plurality of communities are used to select novel expressions specifically used in those communities.

As described above, there is created the set of documents used in the plurality of communities (320 in FIG. 3).

(2) Extract N-Gram Collocations (Step 420 in FIG. 4)

(2-1) Extract Collocations Specific to Communities

There are statistically extracted word-level n-gram collocations which significantly appear when used in a specific community. They are referred to as collocations specific to the community. A detailed description will now be given thereof.

The n-gram collocations imply consecutive one or more words, and a case of one word is referred to as Uni-gram; a case of two words, Bi-gram; and a case of three words, Tri-gram. This embodiment uses bi-grams and tri-grams (330 in FIG. 3).

(2-2) Determination Based on Statistical Significance

If n-gram collocations are simply obtained, the number thereof becomes large. All the n-gram collocations are not always effective. Sets of documents used by two communities are thus compared to select n-gram collocations which are used by one community, and appear in the one community with a significant orientation (Z test). According to this embodiment, there is used a method where ratios of the appearance of each of the n-gram collocations in the two document sets, and the difference between the ratios is tested (330 in FIG. 3). It is assumed that a certain n-gram collocation W appears in both document sets d1 and d2, and the respective frequencies thereof are denoted as w1 and w2. It is also assumed that the total number of the terms appearing in the document set d1 is n1, and that in the document set d2 is n2. The proportions of the term W appearing in the respective document sets are represented as:

p1=w1/n1, and (Equation 1)

p2=w2/n2 (Equation 2)

When sample ratios are the ratios obtained from the actual data, p1 and p2 are sample ratios.

If p1>p2, it is tested whether this is significant or not, namely it is tested whether the n-gram collocation W presents a significant orientation toward the documents in the set d1 (one-sided test).

A null hypothesis and an alternative hypothesis are represented as:

H0: pi1=pi2 Null hypothesis

H1: pi1>pi2 Alternative hypothesis of the one-sided test

In order to carry out the test, a population proportion pihat (Equation 3), which is not actually known, is first estimated from the sample proportions.

pihat=(n1*p1+n2*p2)/(n1+n2) (Equation 3)

Based on this equation, z is calculated by (Equation 4):

z=(p1−p2)/√pihat*(1−pihat)*(1/n1+1/n2)) (Equation 4)

In order to reject the null hypothesis, and to employ the alternative hypothesis, z>1.65 must be satisfied at a risk of 5%.

In this way, all the collocations are tested to respectively select n-gram collocations which significantly appear in documents used in one community, and n-gram collocations which significantly appear in document used in the other community from the n-gram collocations appearing in the document sets. As a result, there are not selected the n-gram collocations which are commonly used in both the communities.

In this embodiment, lists of 2-grams and 3-grams which significantly appear in a set of documents used by wine lovers, and in a set of documents used by Japanese rice wine lovers are extracted for the Z test. As a result of the Z test, n-grams whose Z value is 1.65 or more are selected from the set of the documents used by the wine lovers.

(3) Select Core Elements of Novel Expressions (Word Stems) (Step 430 in FIG. 4)

Elements which are to be cores of novel expressions are selected from the n-grams extracted by the above method (340 in FIG. 3). In order to do so, connections of the n-grams are once disconnected, and there is created a list of all resulting elements (morphemes). Elements which are not possibly to be cores are removed from the list. As the elements which are not possibly to be cores include generic particles, auxiliary verbs, conjunctions, functional words such as conjugational endings, and juncture elements such as “,”, “∘”, and “?”. Moreover, “single-character hiraganas” and “single-character katakanas” are excluded. As a result, there is created a list of elements which are possibly to be cores of novel expressions (core list).

(4) Select Extended Word Stems (Step 440 in FIG. 4)

(4-1) Extension of Word Stems

It is determined whether it is necessary to extend the respective word stem candidates by including previous and subsequent elements based on a distribution of collocation patterns (350 in FIG. 3).

On this occasion, Zᵣₐₜᵢₒ is defined as (Equation 5).

Zᵣₐₜᵢₒ=Z[X]/AvgZ([X][X+1]), (Equation 5)

where Z[X] denotes a Z value of an n-gram word stem of interest. [X+1] denotes an element extended by one word, and [X+2] denotes an element extended by two words from the core element X. AvgZ(N[X+1]) denotes an averaged value of Z values of all (n+1)-gram word stems corresponding to [X][X+1] when n-gram cores are extended to “right-hand” side by one word (0<Zᵣₐₜᵢₒ).

More precisely, there may also be AvgZ([X−1][X]) which is obtained when the n-gram word stems are extended to the “left-hand” side by one word. Thus, hereinafter in this specification, Zᵣₐₜᵢₒ implies the both cases where an n-gram word stem is extended to the “left-hand” side and “right-hand” side by one word unless otherwise specified. Moreover, for the sake of data processing, a logarithm of Zᵣₐₜᵢₒ is defined by (Equation 6).

LZ=10*log(Zᵣₐₜᵢₒ) (Equation 6)

(4-2) Right-Hand Extension Rules

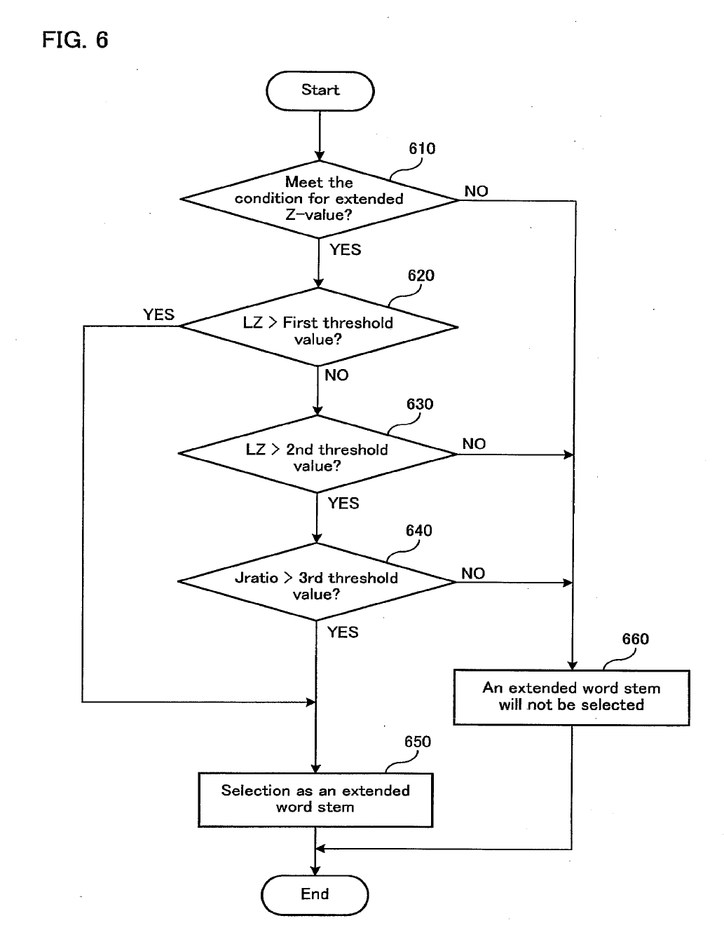

The algorithm shown in FIG. 6 illustrates the process in which an n-gram word stem is extended to the right-hand side by one word, according to the rules explained below (356 in FIG. 3). The rules will not be applied, however, if the final word of the sequence of [X+1] or [X+2] is a juncture element.

First Conditions

If (i) Z([X],[X+1])>AvgZ([X],[X+1],[X+2]), and

(ii) LZ>first threshold,

are satisfied, an n-gram word stem is selected as a candidate to extend to [X+1] (610, 620, 650). The first threshold is 5.0 according to this embodiment, Z([X],[X+1]) is a Z value of an (n+1)-gram represented by ([X][X+1]), and AvgZ([X],[X+1],[X+2]) is an average value of Z values of all (n+2)-grams corresponding to [X], [X+1], and [X+2]. It should be noted that the first threshold is set to high for LZ used in the first condition. If this value is high, it is considered that a word stem can be sufficiently determined as a novel expression only by the determination according to the Z value, and the word stem is thus selected as a possible novel expression regardless of a value of Jratio (described later).

If the first conditions, namely both the conditions (i) and (ii) are satisfied, the word stem is selected as a candidate of an extended word stem (650). If the condition (i) is not satisfied, the word stem is not selected as a candidate to be extended (660). If the condition (i) is satisfied, and the condition (ii) is not satisfied, a determination is made based on the following second conditions (630, 640).

Second Conditions

If (ii) LZ>second threshold, and

(iv) Jratio=Njun/Nall>third threshold

are satisfied, the n-gram word stem is selected as a candidate to be extended to [X+1] (630, 640, 650).

The second threshold used in the second condition for LZ is set to 3.0 according to this embodiment, and only if LZ is larger than this value, and Jratio is 0.1 or more, it is determined that the word stem is possibly a novel expression.

Jratio denotes a ratio that the [X+2] element is a juncture element (0=<Jratio=<1). Further, the third threshold is set to 0.1 according to this embodiment, Njun denotes the number of terminal elements [X+2] determined as a juncture element, and Nall denotes the number of (n+2)-grams corresponding to [X+2] to be considered.

If the second conditions, namely both the conditions (iii) and (iv) are satisfied, the word stem is selected as a candidate of an extended word stem (650). If any one of the conditions (i) and (ii) is not satisfied, the extended word stem is not selected (660).

(4-3) Left-Hand Extension Rules

Basically, left-hand extension rules are similar to the right-hand extension rules (354 in FIG. 3). The above conditions (i), (ii), and (iii) in this case. However, how to count the juncture elements is different in condition (iv). For the right-hand extension rule, a conjugational ending of a verb of interest such as [neru] appearing in [hi][neru] is not considered as a juncture element. However, for the left-hand extension rule, it is hard to consider that a conjugational ending of a verb present on the left-hand side of a word stem under consideration is used as a prefix of a novel expression of the word stem under consideration. Thus, in this case, the element is counted as a juncture element. Namely, on the left-hand side is added an element which is counted as a juncture element.

(4-4) Application Example of Right-Hand Extension Rules

A description will now be given of the right-hand extension rules based on a specific example. The description will be given of an extension of “furuuthii” (Z value: 147.14) selected as a word stem to be extended on the right-hand side.

| Word stem | Extension | | |
|---|---|---|---|
| [X] | [X + 1] | [X + 2] | Z value |
| [furuuthii] | [sa] | | 5.66 |
| [furuuthii] | [sa] | [ga] | 2.00 |
| [furuuthii] | [sa] | [ha] | 2.00 |

In this case, the word stem of interest is “furuuthii”. First, there is considered a case to extend the word stem to the right-hand side by one word. [furuuthii] and [sa] respectively correspond to [X] and [X+1] described above.

In this state, Z value is represented as:

Z([X],[X+1])=Z([furuuthii],[sa])=5.66

The word stem is further extended by one word to the right-hand side, and ([X],[X+1],[X+2]) is considered. There are found two collocations. Namely, they are [furuuthii][sa][ga] and [furuuthii][sa][ha].

Z value of [furuuthii][sa][ga]=Z([furuuthii],[sa],[ga])=2.00

Z value of [furuuthii][sa][ha]=Z([furuuthii],[sa],[ha])=2.00

The elements [X+2], namely [ga] and [ha] are referred to as kOne element. If there are a plurality of kOne elements as in this example, an average value of the Z values thereof is obtained. In this case, both of the Z values are 2.00, and the average value thereof is thus 2.00.

Namely, AvgZ([X],[X+1],[X+2])=2.00, and LZ is then obtained.

Zratio=Z([X],[X+1])/AvgZ([X],[X+1],[X+2])=5.66/2.00=2.83

LZ=10*log(Zratio)=4.52

It is then checked whether or not the kOne elements are “juncture element”, which indicates a juncture. Namely, it is checked whether there is an element indicating a grammatical juncture after a novel expression candidate “furuuthiisa”. If there is a juncture element, it suggests that the candidate (“furuuthiisa (fruity-ness)”) is considered as a grammatically grouped element, and the element becomes a candidate of a novel expression. On this occasion, both “ga” and “ha” are case-marking particles, and thus are elements indicating a grammatical juncture. Namely, it is hardly considered that they are connected to the element (“furuuthiisa”) to create a larger grouped expression or word. Jratio is a ratio of juncture elements to kOne elements. In this case, both of them are juncture elements, and thus, Jratio=2/2=1.

Once the above preparation has been completed, possible candidates as novel expressions are detected. First, the word stems are considered in terms of the following first conditions.

First Conditions

(i) Z([X],[X+1])>AvgZ([X],[X+1],[X+2]), and

(ii) LZ>first threshold

Since Z([furuuthii],[sa])=5.66 and AVG-Z([X],[X+1],[X+2])=2.00, the condition (i) is satisfied.

Since LZ=10*log(Zratio)=4.52, and the first threshold=5.0, the condition (ii) is not satisfied. Thus, the first conditions are not satisfied, and the second conditions are to be considered.

Second Conditions

(iii) LZ>second threshold, and

(iv) Jratio=Njun/Nall>third threshold

Since LZ=4.52 and the second threshold is 3.0, the condition (iii) is satisfied. Since Jratio=2/2=1 and the third threshold is 0.1, the condition (iv) is satisfied.

The second conditions are satisfied, and “furuuthii” is thus extended to “furuuthiisa”. The Z value of [furuuthiisa]=Z([furuuthii],[sa])=5.66.

(4-5) Application Example of Left-Hand Extension Rules

A description will now be given of the left-hand extension rules using a specific example. The description will be given of an extension of “uke (taste, favored)” (Z value: 73.01) selected as a word stem to be extended to the left-hand side.

| Word stem | Extension | | |
|---|---|---|---|
| [X − 2] | [X − 1] | [X] | Z value |
| | [mo] | [uke] | 6.83 |
| [ni] | [mo] | [uke] | 2.83 |
| | [jyosei] | [uke] | 6.83 |
| [,] | [jyosei] | [uke] | 2.00 |
| [amari] | [jyosei] | [uke] | 2.00 |

Since the example is similar to the example of the right-hand extension rules, the extension is also carried out to the left-hand side.

First, the following first conditions are considered.

(i) Z([X−1],[X])>AvgZ([X],[X−1],[X−2]), and

(ii) LZ>first threshold

Since Z([X−1],[X])=6.83 and AvgZ([X],[X−1],[X−2])=2.00, the condition (i) is satisfied. Since LZ=5.33 and the first threshold is 5.0, the condition (ii) is also satisfied.

As a result, [uke] is extended to [joseiuke (female-favored)]. The Z value of [joseiuke]=Z([joseiuke])=5.33.

(5) Select Novel Expressions (Step 450 in FIG. 4)

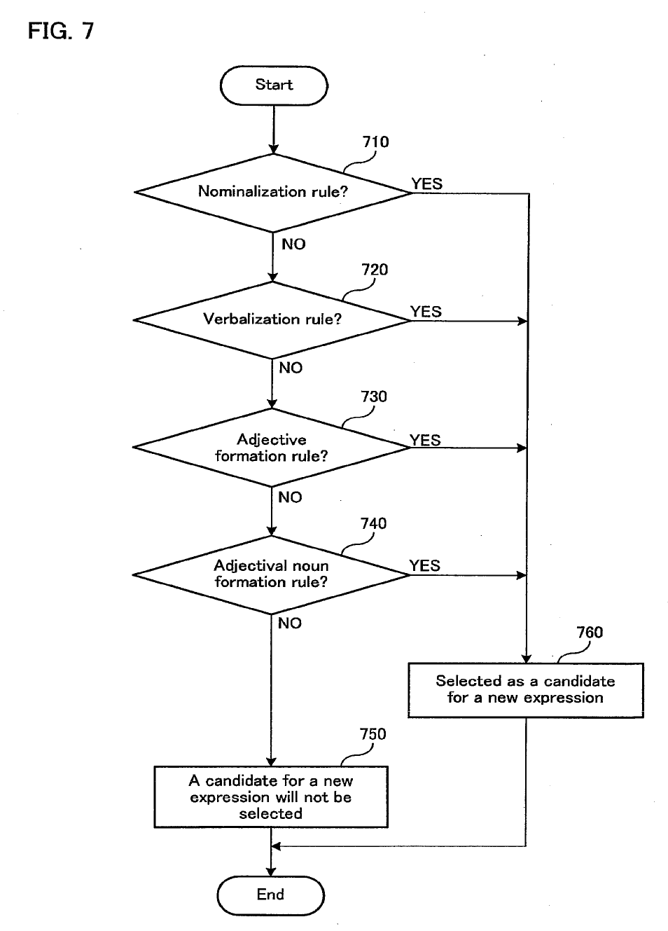

Candidates meeting word formation rules are selected as novel expressions from the candidates meeting the conditions of the extension (360 in FIG. 3). Words which highly possibly generate novel expressions must follow the Japanese word formation rules, and the word formation rules are limited (365 in FIG. 3). In order to select the candidates meeting word formation rules as the novel expressions, it is necessary to check whether a part where the extension of phrasing is generated follows the rules to form a noun, a verb, an adjective, an adjective verb, and the like. A description will be given with reference to a flowchart shown in FIG. 7.
710: Nominalization rule
720: Verbalization rule
730: Adjective formation rule
740: Adjective-verb formation rule
750: If all the conditions are not met, do not select as a candidate
760: If any of the conditions are met, select as a candidate

A detailed description will now be given below.

(5-1) Nominalization Rules (Step 710)

A word which meets the nominalization rules is selected as a candidate of the extension of the word stem. The nominalization includes “word stem+suffix”, “verb continuous form nominalization”, and “compound noun”. It is necessary to check whether they respectively satisfy the rules as Japanese.

(a) Word Stem+Suffix

When an adjective or the like other than a noun is nominalized, “sa”, “mi”, or the like is added to an ending thereof. There are following examples.

“sa” (ususa, kanasisa, homeraretasa)

“ke” (samuke, nemuke, hakike, kazarike)

“mi” (tsuyomi, iyami, sugomi)

(b) Verb Continuous Form Nominalization

A verb continuous form can be nominalized when followed by a case-marking particle or a noun to the right side of the word stem. There are following examples.

“Hashiru (V)” to “hashiri (N)”, “aruki (N)”

“asobu (V)” to “asobi (N)”

(c) Compound Noun

A word stem considered as a compound noun is selected as a candidate of the extension of a word stem. There are following examples.

In a case where [mai] is added to an ending of a word: [kake][mai], [kouji][mai], [jyun][mai], [aka][mai]

In a case where [kou] is added to an ending of a word: [banana][kou], [ginjyou][kou], [zyukusei][kou]

(d) Nominalization of English Word

The present invention is not only applicable to Japanese but also to foreign languages. A description will now be given of English as an example. In English, there are cases where parts of speech which are not originally nouns, but are used as nouns. They are nominalized by adding the following suffixes, for example.

“ness”: pleasantness, ugliness

“ing”: gathering

“ful”: earful

“dom”: femidom

“hood”: brotherhood, womanhood

(5-2) Verbalization Rules (Step 720)

A word which meets the verbalization rules is selected as a candidate of an extension of a word stem. As an example of the verbalization, there can be “noun+suru”, “general conjugational form of verb”, and the like. It is necessary to check whether a word selected as a candidate of the extension satisfies the rules of Japanese.

(a) Form of “Noun+Verbalizing Suffix”

When a verbalizing suffix such as “suru” or “buru” or a conjugational form thereof is connected to a noun, the word is selected as a candidate of a verbalizing extension of a word stem. For example, there are “ochasuru”, which is constructed by connecting “suru” to “ocha”, and “bizinburu”, which is constructed by connecting “buru” to “bijin”.

(b) General Conjugational Form of Verb

If an extended word stem is in a general conjugational form of a verb other than a form of “noun+verbalizing suffix”, the word stem is selected as a candidate of an extension of a word stem. For example, productive examples of verbalization by adding a conjugational ending of a verb to a noun includes “demoru, demoranai, demoreba . . . ”. There can be created new verbs such as “gebaru, hamoru, tsumoru, and guguru” in a similar manner.

(c) Verbalization of English Word

The present invention is not only applicable to Japanese but also to foreign languages. A description will now be given of English as an example. In English, there are cases where parts of speech which are originally nouns are used as verbs; “Are you googling?”

This is an example of “google”, which is originally a noun, is used as “search by means of google”, which is a verb.

I 747'ed to Chicago.

This is an example of “747”, which is a model number of an airplane, is used as “flew on a 747 airplane”, which is a verb.

In addition, verbalization is carried out by the following suffixes.

“ify”: Frenchify

“en”: enliven, soften

“ize”: pluralize

(5-3) Adjective Formation Rules (Step 730)

A word which meets the adjective formation rules is selected as a candidate of an extension of a word stem. It is necessary to check whether a word selected as a candidate of the extension satisfies the rules of Japanese.

“i” (sindoi, sikakui)

“koi” (nechikkoi)

“poi” (onnappoi, soreppoi)

(5-4) Adjective-Noun Formation Rules (Step 740)

A word which meets the adjective-noun formation rules is selected as a candidate of the extension of the word stem. It is necessary to check whether a word selected as a candidate of the extension satisfies the rules of Japanese.

“fuu” (ouchoufuu, regeifuu)

“na” (makkuna [hito])

“ge” (ureshige, yosage, nanige)

When the word stem satisfies any of the above conditions in Steps 710 to 740, the word stem is selected as a candidate of the extension of the word stem (760). When the word stern satisfies none of the conditions, the word stem is not selected as a candidate of the extension of the word stem.

Experimental Results

The following section provides experiment results based on actual data according to the above algorithm. In this experiment, the “community discussing tastes of sake” and the “community discussing tastes of wines” are selected as communities to be considered. Brand names of sake and wines are used as keywords to collect respective sets of documents by means of search tools for the Internet.

(1) Nominalization

(1-1) Word Stem+Suffix

A description will now be given of an example of the nominalization of an adjective. The description will given of an example where an adjective “furuuthi” is nominalized into “fruuthisa”

| Word stem | Extension | | |
|---|---|---|---|
| [X] | [X + 1] | [X + 2] | Z value |
| [furuuthii] | [sa] | | 5.66 |
| [furuuthii] | [sa] | [ga] | 2.00 |
| [furuuthii] | [sa] | [ha] | 2.00 |

[furuuthi] is extended to [fruuthisa] as described above.

It is then checked whether the extended word stem satisfies the nominalization rule (word stem+suffix). When an adjective other than a noun is nominalized, “sa”, “mi”, or the like is added to the word stem. This embodiment satisfies this condition.

As a result, “fruuthisa”, which is a noun extended from “fruuthi”, is selected as a new word stem. The LZ value used to determine “fruuthi”+“sa” is 4.52.

(1-2) Verb Continuous Form Nominalization

A description will now be given of an extension of “uke” (Z value: 73.01) selected as a word stem to extend to the left-hand side.

| | |
|---|---|
| Extension | Word stem |

| [X − 2] | [X − 1] | [X] | Z value |
|---|---|---|---|
| | [mo] | [uke] | 6.83 |
| [ni] | [mo] | [uke] | 2.83 |
| | [jyosei] | [uke] | 6.83 |
| [,] | [jyosei] | [uke] | 2.00 |
| [amari] | [jyosei] | [uke] | 2.00 |

[uke] is extended to [joseiuke] as described above. It is then checked whether the extended word stem satisfies the rule (verb continuous form nominalization). [josei (woman)] is apparently a noun. There is observed a collocation of “uke” followed by a case-marking particle, which is considered as nominalization by a verb continuous form, and “josei” and “uke” are thus considered as nominalization by a verb continuation form. Accordingly, the condition is satisfied.

As a result, “josei” and “uke” are selected as new word stems. The LZ value used to determine “josei” and “uke” is 5.33.

(1-3) Compound Noun

A description will now be given of an extension of “yuki” (Z value: 66.96) selected as a word stem to the left-hand side.

| Word stem | Extension | | |
|---|---|---|---|
| [X] | [X + 1] | [X + 2] | Z value |
| [yuki] | [no] | | 4.00 |
| [yuki] | [no] | [naka] | 2.00 |
| [yuki] | [on] | | 4.00 |
| [yuki] | [on] | [de] | 2.00 |
| [yuki] | [shitsu] | | 4.00 |

As a result of consideration according to the previous condition, it is understood that [setsu] is extended to [setsuon]. A detailed description is omitted here. It is then considered whether the extended word stem satisfies the nominalization rule (compound noun). It is apparent that [setsu (snow)] and [on (temperature)] are nouns, and this condition is thus satisfied.

As a result, “setsuon” is selected as a new word stem. The LZ value used to determine “setsuon” is 3.01.

There are following other examples of the extension as compound nouns.

[kake][mai], [kouji][mai], [jyun][mai], [aka][mai] where [mai (rice)] is a word stem

[banana][kou], [ginjyou][kou], [jyukusei][kou] where [kou (flavor)] is a word stem

[masukatto][you], [ringo][you], [kajitsu][you] where [you (-like)] is a word stem

[aminosan][do], [arukooru][do], [nihonsyu][do] where [do (degree)] is a word stem

(2) Verbalization

(2-1) “Noun+Verbalization Suffix”

A description will now be given of a detection of a verbalization pattern such as “noun+suru”. On this occasion, “waruyoi” (Z value is 24.01) is selected to extend to the right hand.

| | |
|---|---|
| Left-hand Extension | Word stem |

| [X − 2] | [X − 1] | [X] | Z value |
|---|---|---|---|
| | [waruyoi] | [suru] | 4.00 |
| [kara] | [waruyoi] | [suru] | 2.00 |
| | [shiyou] | [suru] | 2.00 |

As a result of consideration according to the previous condition, it is possible to extend “waruyoi” to “waruyoisuru” to create a new word stem. A detailed description is omitted here.

It is then checked whether the extended word stem satisfies the verbalization rule (“noun+suru”). In this example, since “suru” or a conjugational form of “suru” is connected to a noun, the condition is met.

As a result, “waruyoisuru” is selected as a new word stem. The LZ value used to determine “setsuon” is 3.01.

Although it is considered that “waruyoisuru” is a word used generally, it is observed that the word appears with a significant difference in the “community discussing tastes of sake” compared to the “community discussing tastes of wines”.

There are following other examples of the extension as verbalization.

[jouzou][suru] where [jouzou] is word stem, [chouwa][suru] where [chouwa] is word stem, [toujyou][suru] where [toujyou] is word stem, and [baizou][suru] where [baizou] is word stem.

(2-2) General Conjunctional Form of Verb

A description will now be given of examples where “word stem+extended portion” forms one new verb when a verb is conjugated according to the grammar.

For example, there are acquired data such as [hi][ne] (read as: hine), [hi][neta] (read as: hineta), [hi][ne][ga, wo (case-marking particles)] (read as: hinega, hinewo) from patterns used in the Japanese rice wine community.

| Word stem | Right-hand Extension | Z value |
|---|---|---|
| [hi] | [neru] (read as: hineru) | 2.05 |
| [hi] | [neta] (read as: hineta) | 2.05 |

According to the above algorithm, [symbol] (read as: hineru) (ichidan conjugational form of verb) is selected as a candidate. On this occasion, [symbol] (read as: oi) is registered as a general noun in dictionaries, a kamiichidan verb, [symbol] (read as: oiru) is registered as a verb. Based on data and verb conjugation rules, it is determined that there occurs an extension to a simoichidan verb: [ [symbol] ] (read as: hineru). Moreover, based on data such as [ [symbol] ][ [symbol] ]+[case-marking particle], it is observed that there occurs a nominalization where a verb continuous form [ [symbol] ] (read as “hine”) is used as a noun. It is estimated that [ [symbol] ] (read as “hineru”) is used as a common word as a novel expression in this community.

### DESCRIPTION OF SYMBOLS

110: user PC
120: site server (1)
130: site server (2)
140: network
200: enclosure
210: storage device
220: main memory
230: output device
240: central processing unit (CPU)
250: console unit
260: network I/O

What is claimed is:

1. A device for searching for an expression specific to a predetermined community from a set of documents used in the predetermined community, the device comprising the following means (a) to (d):
(a) means for extracting an n-gram collocation specifically used by the community;
(b) means for selecting a first word stem which is a possible core of a specific expression;
(c) means for selecting an extended word stem based on values calculated using a statistical significance of the first word stem, and a statistical significance of a second word stem which contains a previous or subsequent element of the first word stem; and
(d) means for selecting an expression specific to the predetermined community from the extended word stems according to a word formation rule of a certain language.

2. A device according to claim 1, further comprising means for collecting documents for the set of documents by means of data search by using a term contained in a predetermined term list as a keyword.

3. A device according to claim 1, wherein the means for extracting an n-gram collocation comprises means for using a document used in a plurality of communities to extract an n-gram collocation based on a comparison between a statistical significance of the n-gram collocation used in the predetermined community and a statistical significance of the n-gram collocation used in other communities.

4. A device according to claim 1, wherein the means for selecting an extended word stem further comprises means for selecting an extended word stem based on the number of second word stems and a value calculated using the number of second word stems which contains a juncture element.

5. A device according to claim 1, wherein the means for selecting an expression according to the word formation rule comprises at least one of a nominalization rule, a verbalization rule, an adjective formation rule, and an adjective-noun formation rule.

6. A method for searching for an expression specific to a predetermined community from a set of documents used in the predetermined community, the method comprising the steps of:
(a) extracting an n-gram collocation specifically used by the community;
(b) selecting a first word stem which is a possible core of a specific expression;
(c) selecting an extended word stem based on values calculated using a statistical significance of the first word stem, and a statistical significance of a second word stem which contains a previous or subsequent element of the first word stem; and
(d) selecting an expression specific to the predetermined community from the extended word stems according to a word formation rule of a certain language.

7. A method according to claim 6, further comprising the step of collecting documents for the set of documents by means of data search by using a term contained in a predetermined term list as a keyword.

8. A method according to claim 6, wherein the step of extracting an n-gram collocation comprises the steps of using a document used in a plurality of communities to extract an n-gram collocation based on a comparison between a statistical significance of the n-gram collocation used in the predetermined community and a statistical significance of the n-gram collocation used in other communities.

9. A program for searching for an expression specific to a predetermined community from a set of documents used in the predetermined community, the program controlling a computer to operate the following means (a) to (d):
(a) means for extracting an n-gram collocation specifically used by the community;
(b) means for selecting a first word stem which is a possible core of a specific expression;
(c) means for selecting an extended word stem based on values calculated using a statistical significance of the first word stem, and a statistical significance of a second word stem which contains a previous or subsequent element of the first word stem; and
(d) means for selecting an expression specific to the predetermined community from the extended word stems according to a word formation rule of a certain language.

10. A program according to claim 9, further comprising means for collecting documents for the set of documents by means of data search by using a term contained in a predetermined term list as a keyword.

11. A program according to claim 9, wherein the means for extracting an n-gram collocation comprises means for using a document used in a plurality of communities to extract an n-gram collocation based on a comparison between a statistical significance of the n-gram collocation used in the predetermined community and a statistical significance of the n-gram collocation used in other communities.
